(19) United States
(12) Patent Application Publication
(10) Pub. No.: US 2026/0332752 A1
(43) Pub. Date: Oct. 22, 2026

(54) METHOD AND APPARATUS FOR ENCODING/DECODING IMAGE AND A RECORDING MEDIUM FOR STORING A BITSTREAM

(71) Applicants: HYUNDAI MOTOR COMPANY, Seoul (KR); KIA CORPORATION, Seoul (KR)

(72) Inventors: Jin Heo, Yongin-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 19/114,666

(22) PCT Filed: Oct. 13, 2023
(86) PCT No.: PCT/KR2023/015888

§ 371 Date: Mar. 24, 2025

(30) Foreign Application Priority Data
Oct. 14, 2022 (KR) 10-2022-0131967
Oct. 13, 2023 (KR) 10-2023-0136952

(51) Int. Cl. H04N 19/11; H04N 19/105; H04N 19/119; H04N 19/176

(52) U.S. Cl. CPC H04N 19/11; H04N 19/105; H04N 19/119; H04N 19/176

(57) ABSTRACT

Provided is an image decoding method comprising partitioning a current block into a first partition and a second partition according to a partitioning boundary, determining a first intra prediction mode for the first partition and a second intra prediction mode for the second partition, determining a first prediction block for the first partition according to the first intra prediction mode and a second prediction block for the second partition according to the second intra prediction mode, and determining a final prediction block from the first prediction block and the second prediction block.

### CROSS-REFERENCE TO RELATED APPLICATIONS

This is a U.S. national stage of International Application No. PCT/KR2023/015888, filed on Oct. 13, 2023, which claims priority to Korean Patent Application No. 10-2022-0131967 filed on Oct. 14, 2022, and Korean Patent Application No. 10-2023-0136952, filed on Oct. 13, 2023, the entire contents of each of which are hereby incorporated herein by reference.

### TECHNICAL FIELD

The present invention relates to an image encoding/decoding method and apparatus and a recording medium for storing a bitstream. More particularly, the present invention relates to an image encoding/decoding method and apparatus using an intra prediction method and a recording medium for storing a bitstream.

### BACKGROUND

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In intra prediction, a method of partitioning a coding unit block into partitions having various shapes and predicting each partition according to a different intra prediction method has been discussed. At this time, various methods of determining an appropriate intra prediction mode of each partition and accurately predicting each partition according to the intra prediction mode have been discussed.

### SUMMARY

An object of the present invention is to provide an image encoding/decoding method and apparatus with improved encoding/decoding efficiency.

Another object of the present invention is to provide a recording medium for storing a bitstream generated by an image decoding method or apparatus provided by the present invention.

An image decoding method according to an embodiment of the present invention may comprise partitioning a current block into a first partition and a second partition according to a partitioning boundary, determining a first intra prediction mode for the first partition and a second intra prediction mode for the second partition, determining a first prediction block for the first partition according to the first intra prediction mode and a second prediction block for the second partition according to the second intra prediction mode, and determining a final prediction block from the first prediction block and the second prediction block.

According to one embodiment, the first intra prediction mode may be determined from a first reference pixel adjacent to the first partition and the second intra prediction mode may be determined from a second reference pixel adjacent to the second partition.

According to one embodiment, a first histogram of gradients representing a gradient distribution of a reference pixel may be generated from the first reference pixel and an intra prediction mode corresponding to a gradient with a highest frequency in the first histogram of gradients may be determined to the first intra prediction mode, and a second histogram of gradients representing a gradient distribution of a reference pixel may be generated from the second reference pixel and an intra prediction mode corresponding to a highest frequency in the second histogram of gradients may be determined to be the second intra prediction mode.

According to one embodiment, the image decoding method may comprise obtaining intra prediction mode determination method information indicating a method of deriving a method of deriving the first intra prediction mode and a method of deriving the second intra prediction mode, and the first intra prediction mode and the second intra prediction mode may be determined according to the intra prediction mode determination method information.

According to one embodiment, the intra prediction mode determination method information may indicate a first determination method for deriving an intra prediction mode from adjacent reference pixels or a second determination method for deriving an intra prediction mode from intra prediction mode information obtained from a bitstream.

According to one embodiment, the intra prediction mode determination method information may independently indicate a determination method of the first intra prediction mode and a determination method of the second intra prediction mode.

According to one embodiment, the first prediction block may be determined by referring to a reference pixel of the current block according to the first intra prediction mode, the second prediction block may be determined by referring to the reference pixel of the current block according to the second intra prediction mode, and the first prediction block and the second prediction block may be independently determined.

According to one embodiment, the first prediction block may be determined by referring to a reference pixel of the current block according to the first intra prediction mode, the second prediction block may be determined by referring to a second reference pixel adjacent to the second partition and a reconstructed pixel of the first prediction block according to the second intra prediction mode, and the first prediction block may be determined and then the second prediction block may be determined.

According to one embodiment, the second prediction block may be determined from a third reference pixel derived from the reconstructed pixel of the first prediction block and a second reference pixel adjacent to the second partition, and the third reference pixel may replace a first reference pixel adjacent to the first partition.

According to one embodiment, a value of the third reference pixel may be determined by copying a value of the reconstructed pixel of the first prediction block or by combining two or more reconstructed pixels of the first prediction block based on the reconstructed pixel of the first prediction block and a distance from the third reference pixel.

According to one embodiment, the image decoding method may further comprise determining a width of a blending area around the partitioning boundary and determining a first weight and a second weight for determining a final prediction sample of the blending area based on the width of the blending area, and the final prediction block may be determined from the first prediction block and the second prediction block, based on the first weight and the second weight.

According to one embodiment, in the determining the width of the blending area, the width of the blending area may be determined based on a size value of the current block.

According to one embodiment, the width of the blending area may be determined according to a size interval including the size value of the current block.

According to one embodiment, the width of the blending area may be selected from among a plurality of width candidates corresponding to a size interval including the size value of the current block.

According to one embodiment, the width of the blending area may be selected from among a plurality of width candidates based on blending area width information indicating the width of the blending area parsed from a bitstream.

According to one embodiment, the size value of the current block may be determined by at least one of a width of the current block, a height of the current block, a larger value among the width and height of the current block, a smaller value among the width and height of the current block, or a ratio of the width and height of the current block.

According to one embodiment, the width of the blending area may be determined depending on whether a current picture or a current slice including the current block is a screen content image. The width of the blending area may be determined to be 0 or ¼ when a current picture or a current slice including the current block is a screen content image.

According to one embodiment, in the determining the first weight and the second weight, determining the first weight and the second weight based on the width of the blending area may be included.

According to one embodiment, the determining the first weight and the second weight may comprise determining a maximum value of the first weight and the second weight based on the width of the blending area and determining the first weight and the second weight based on the maximum value.

According to one embodiment, in the determining the maximum value of the first weight and the second weight, the maximum value of the first weight and the second weight may be set to be larger as the width of the blending area increases.

According to one embodiment, the determining the first weight and the second weight may comprise determining the maximum value of the first weight and the second weight based on width candidates of the blending area applied to the current block and determining the first weight and the second weight based on the maximum value.

According to one embodiment, in the determining the maximum value of the first weight and the second weight, the maximum value of the first weight and the second weight may be determined based on a largest width candidate or a smallest width candidate among the width candidates of the blending area.

According to one embodiment, in the determining of the first weight and the second weight, the first weight and the second weight may be determined based on a position of a sample of the blending area and a distance from the partitioning boundary.

According to one embodiment, an image encoding method may comprise partitioning a current block into a first partition and a second partition according to a partitioning boundary, determining a first intra prediction mode for the first partition and a second intra prediction mode for the second partition, determining a first prediction block for the first partition according to the first intra prediction mode and a second prediction block for the second partition according to the second intra prediction mode, and determining a final prediction block from the first prediction block and the second prediction block.

A non-transitory computer-readable recording medium according to an embodiment of the present invention may store a bitstream generated by the image encoding method.

A transmission method according to an embodiment of the present invention transmits a bitstream generated by the image encoding method.

The features briefly summarized above with respect to the present disclosure are merely exemplary aspects of the detailed description below of the present disclosure, and do not limit the scope of the present disclosure.

The present invention proposes various embodiments of a method of determining an intra prediction mode of each partition in a spatial geometric partitioning mode.

In addition, the present invention proposes various embodiments of a method of determining a prediction block of each partition in a spatial geometric partitioning mode.

In addition, the present invention proposes various embodiments of a method of determining a final prediction block of a current block based on a prediction block of each partition in a spatial geometric partitioning mode. In addition, the present invention proposes various embodiments of a method of determining a weight for a pixel of a prediction block of each partition together with a width of a blending area, for determination of the final prediction block.

According to the various embodiments, as the prediction accuracy of the spatial geometric partitioning mode is improved, the overall encoding efficiency can be improved.

### BRIEF DESCRIPTION OF THE DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 illustrates a first partition, a second partition, and neighboring reference pixels of a current block.

FIG. 5 illustrates two partitions of a current block partitioned in a different form from FIG. 4, and reference pixels of the current block.

FIG. 6 illustrates an embodiment of a method of determining a prediction block of a current block to which a spatial geometric partitioning mode is applied.

FIG. 7 illustrates another embodiment of a method of determining a prediction block of a current block to which a spatial geometric partitioning mode is applied.

FIG. 8 shows a method of combining two prediction blocks that are partitioned using a partitioning boundary to generate a final prediction block.

FIG. 9 shows a graph of weights of a prediction signal of each partition.

FIG. 10 shows a weight for widths of various blending areas.

FIG. 11 shows a maximum value of a weight that is variably determined according to a width of a blending area.

FIG. 12 shows an embodiment of a prediction method according to a spatial geometric division mode according to the present invention.

FIG. 13 exemplary illustrates a content streaming system to which an embodiment according to the present invention is applicable.

### DETAILED DESCRIPTION

An image decoding method according to one embodiment of the present invention may comprise partitioning a current block into a first partition and a second partition according to a partitioning boundary, determining a first intra prediction mode for the first partition and a second intra prediction mode for the second partition, determining a first prediction block for the first partition according to the first intra prediction mode and a second prediction block for the second partition according to the second intra prediction mode, and determining a final prediction block from the first prediction block and the second prediction block.

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term is and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

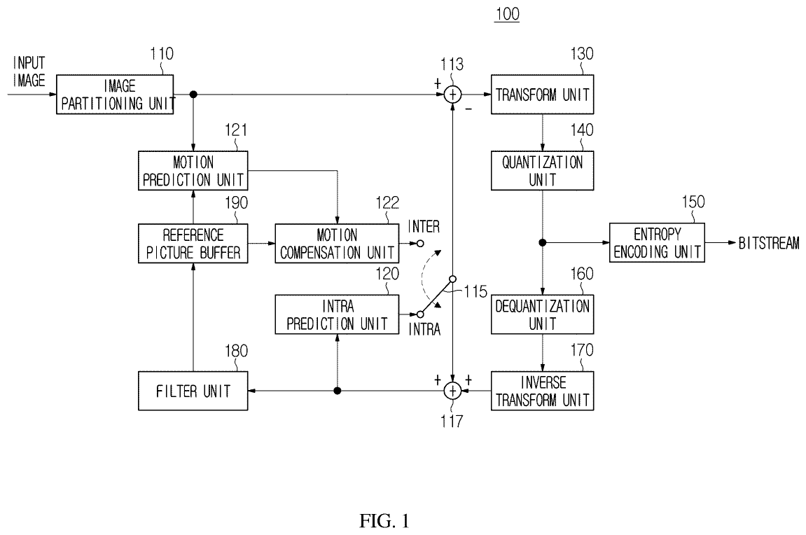

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

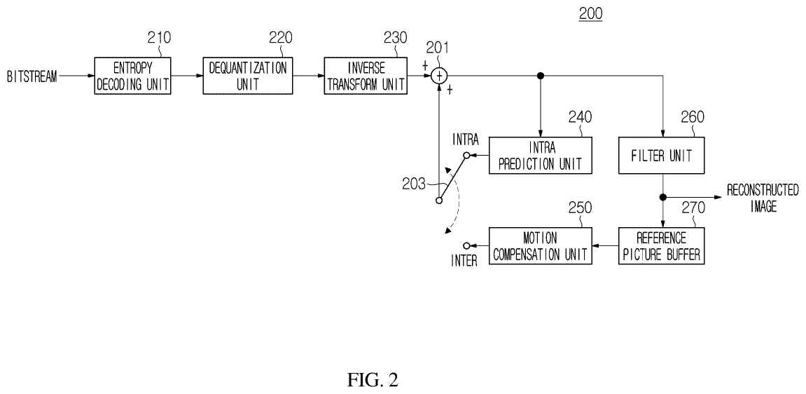

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

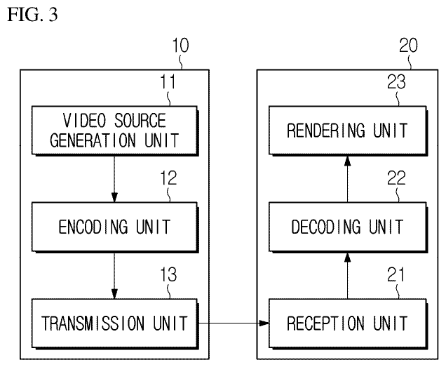

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

In the present invention, various embodiments of a spatial geometric partitioning mode (SGPM) are provided. According to the spatial geometric partitioning mode, a coding unit block is partitioned into two partitions having an arbitrary shape according to a partitioning boundary, and two prediction blocks are generated by performing intra prediction according to different intra prediction modes for the two partitioned partitions, and a final prediction block of the coding unit block is determined by a weighted sum of the two prediction blocks.

In the present invention, various embodiments of a method of deriving an intra prediction mode of each partition of a spatial geometric partitioning mode are provided. In addition, various embodiments of a method of determining a prediction block according to a spatial geometric partitioning mode are provided. In addition, various embodiments of a method of variably adjusting a width and weight of a blending area of a spatial geometric partitioning mode are provided.

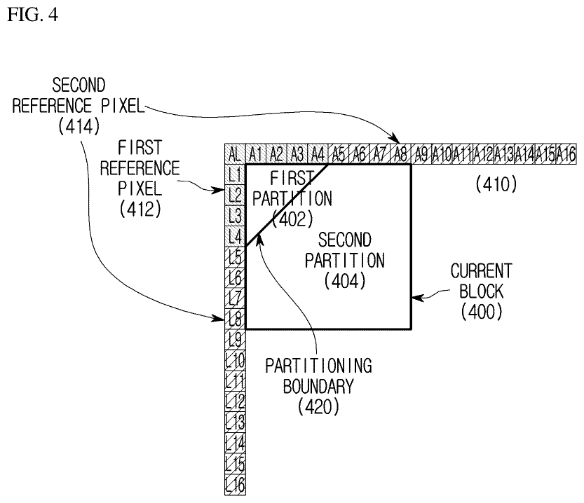

FIG. 4 illustrates a first partition 402, a second partition 404, and neighboring reference pixels 410 of a current block 400.

In FIG. 4, the current block 400 is partitioned into the first partition 402 and the second partition 404 by a predetermined partitioning boundary 420. In FIG. 4, the reference pixels 410 of the current block 400 include AL, A1 to A16, and L1 to L16. Here, A1 to A16 represent above reference pixels and L1 to L16 represent left reference pixels. In addition, AL represents the above left reference pixel.

In FIG. 4, the current block is predicted by the spatial geometric partitioning mode. Therefore, the first partition 402 and the second partition 404 of the current block are intra-predicted, and the first intra prediction mode of the first partition 402 and the second intra prediction mode of the second partition 404 are determined. The first intra prediction mode and the second intra prediction mode may be determined by deriving the intra prediction mode information from the reference pixels of the current block instead of parsing the intra prediction mode information from a bitstream.

In FIG. 4, the reference pixels 410 may be partitioned into first reference pixels 412 (A1, A2, A3, A4, L1, L2, L3, L4, AL) for the first partition and second reference pixels 414 (A5 to A16, L5 to L16) for the second partition based on a straight-line partitioning boundary. The intra prediction mode for the first partition 402 may be derived by applying decoder-side intra prediction mode derivation (DIMD) to the first reference pixels 412 for the first partition. The intra prediction mode for the second partition 404 may be derived by applying decoder-side intra prediction mode derivation to the second reference pixels 414 for the second partition.

According to decoder-side intra prediction mode derivation, the intra prediction mode is derived as follows. First, by applying a Sobel filter to the selected reference pixel, the gradient of the reference pixel is calculated. Based on this, a histogram of gradients (HoG) is generated, and then the intra prediction mode is determined based on the gradient with the largest value.

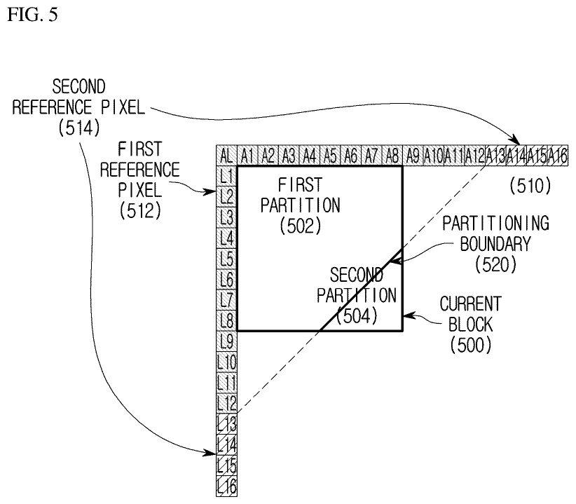

FIG. 5 illustrates two partitions 502 and 504 of a current block 500 partitioned in a different form from FIG. 4, and reference pixels 510 of the current block 500.

The current block 500 is partitioned into the first partition 502 and the second partition 504 by a predetermined partitioning boundary 520. In FIG. 5, the reference pixels 510 of the current block 500 include AL, A1 to A16, and L1 to L16. Here, A1 to A16 represent above reference pixels and L1 to L16 represent left reference pixels. In addition, AL represents the above left reference pixel.

In FIG. 5, similarly to FIG. 4, the current block is predicted by the spatial geometric partitioning mode. Therefore, the first partition 502 and the second partition 504 of the current block are intra-predicted, and the first intra prediction mode of the first partition 502 and the second intra prediction mode of the second partition 504 are determined. The first intra prediction mode and the second intra prediction mode may be determined by deriving the intra prediction mode information from the reference pixels of the current block instead of parsing it from the bitstream.

In FIG. 5, the reference pixels 510 may be partitioned into first reference pixels 512 (A1 to A12, L1 to L12, AL) for the first partition and second reference pixels 514 (A13, A14, A15, A16, L13, L14, L15, L16) for the second partition based on the straight-line partitioning boundary. The intra prediction mode for the first partition 502 may be derived by applying decoder-side intra prediction mode derivation to the first reference pixel 512 for the first partition. The intra prediction mode for the second partition 504 may be derived by applying decoder-side intra prediction mode derivation to the second reference pixel 514 for the second partition.

According to one embodiment, the intra prediction mode of the second partition 504 may be determined from intra prediction mode information parsed from the bitstream. Since the second partition 504 is far from the second reference pixel 514, the prediction accuracy may be low when using the intra prediction mode determined by decoder-side intra prediction mode derivation. Therefore, for partitions that are not adjacent to reference pixels, such as the second partition 504, it may be appropriate to determine the intra prediction mode from the intra prediction mode information parsed from the bitstream.

According to one embodiment, in FIGS. 4 and 5, decoder-side intra prediction mode derivation is applied to reference pixel lines adjacent to the current block to derive intra prediction modes of each partitioned partition. However, as an embodiment, decoder-side intra prediction mode derivation may be applied to reference pixel lines that are N pixels away from the current block, where N is a positive integer.

In FIGS. 4 and 5, the prediction mode of the current block is a spatial geometric partitioning mode. The intra prediction mode for each partitioned partition may be determined by decoder-side intra prediction mode derivation. For the partition to which decoder-side intra prediction mode derivation is applied, intra prediction mode information does not need to be transmitted/parsed.

Hereinafter, a method of determining the intra prediction mode for each partitioned partition when the prediction mode of the current block is a spatial geometric partitioning mode will be described in Table 1.

TABLE 1

| Index | First partition | Second partition |
|---|---|---|
| 0 | intra prediction mode information | intra prediction mode information |
| | transmission/parsing | transmission/parsing |
| 1 | intra prediction mode derivation | intra prediction mode information |
| | | transmission/parsing |
| 2 | intra prediction mode information | intra prediction mode derivation |
| | transmission/parsing | |
| 3 | intra prediction mode derivation | intra prediction mode derivation |

Table 1 shows a combination of methods of determining an intra prediction mode for each partition. In Table 1, ‘intra prediction mode information transmission/parsing’ indicates that the intra prediction mode of the corresponding partition is determined from the intra prediction mode information transmitted from the bitstream. In addition, ‘intra prediction mode information derivation’ indicates that the intra prediction mode of the corresponding partition is derived from reference samples adjacent to the partition.

According to Table 1, index 0 indicates that the intra prediction mode of all partitions is determined from the transmitted intra prediction mode information. Index 1 indicates that the intra prediction mode of the first partition is derived, while the intra prediction mode for the second partition is determined from the transmitted intra prediction mode information. Index 2 indicates that the intra prediction mode of the second partition is derived, while the intra prediction mode for the first partition is determined from the transmitted intra prediction mode information. Index 3 indicates that the intra prediction modes of all partitions are derived.

In addition, the intra prediction mode determination method indicated by indexes 0-3 may be determined differently from Table 1. For example, the intra prediction mode determination method indicated by index 0 in Table 1 and the intra prediction mode determination method indicated by index 3 may be implemented interchangeably.

The method of determining intra prediction mode information of each partition for the spatial geometric partitioning mode may be determined by transmitting/parsing the corresponding index in Table 1. Here, the first partition and the second partition may be determined based on the above left pixel of the current block. That is, the first partition may be defined as a partition including the above left pixel of the current block, and the second partition may be defined as a partition not including the above left pixel of the current block.

The index described in Table 1 may be set to represent all or part of the four intra prediction mode determination methods of Table 1. For example, the index may be set to represent one of the method of index 0 and the method of index 3 of Table 1. Alternatively, the index may be set to represent one of the method of index 1, the method of index 2, and the method of index 3 of Table 1.

According to an embodiment, a method of a specific index of Table 1 may be fixedly applied to a spatial geometric partitioning mode. That is, when a current block is a spatial geometric partitioning mode, the intra prediction mode of the first partition (or the second partition) is always derived, while the intra prediction mode of the second partition (or the first partition) may be determined by parsing the intra prediction mode information. Alternatively, the intra prediction modes for the first partition and the second partition may always be derived. Alternatively, the intra prediction modes for the first partition and the second partition may always be determined by parsing the intra prediction mode information.

According to an embodiment, a method of determining an intra prediction mode may be determined based on a shape of a partition without parsing the index. For example, if a partition is not adjacent to a reference pixel, the intra prediction mode of the corresponding partition may be determined from intra prediction mode information from a bitstream without parsing the index. Alternatively, based on at least one of a partitioning direction and a partitioning point of the partition, the intra prediction mode of one or more partitions may be determined from intra prediction mode information from a bitstream without parsing the index.

Hereinafter, a method of generating a prediction block of a current block according to an intra prediction mode of each partition in a spatial geometric partitioning mode will be described.

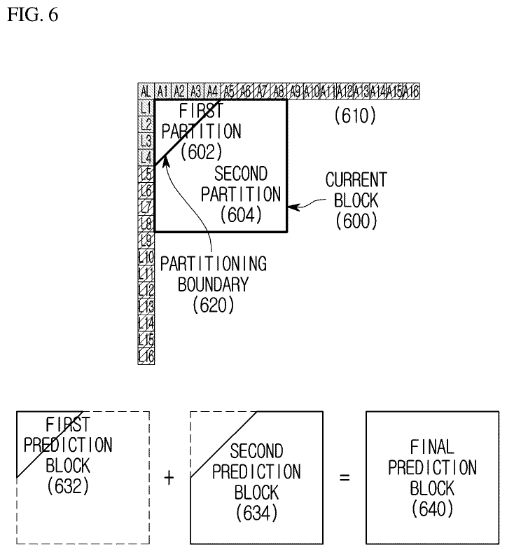

FIG. 6 illustrates an embodiment of a method of determining a prediction block 640 of a current block 600 to which a spatial geometric partitioning mode is applied.

In FIG. 6, the current block 600 is partitioned into a first partition 602 and a second partition 604 by a partitioning boundary 620. The intra prediction mode for the partitions 602 and 604 may be determined according to any method of Table 1. The first prediction block 632 of the first partition 602 and the second prediction block 634 of the second partition 604 may be generated according to the intra prediction mode of each partition. That is, the first prediction block 632 of the first partition 602 may be generated using the neighboring reference pixels A1 to A16, L1 to L16, AL 610 of the current block 600. Additionally, the second prediction block 634 of the second partition 604 may also be generated using the neighboring reference pixels A1 to A16, L1 to L16, AL 610 of the current block 600. The final prediction block 640 of the current block 600 may be generated by combining the first prediction block 632 and the second prediction block 634.

In FIG. 6, only the part corresponding to the first partition 602 of the first prediction block 632 may be used to generate the final prediction block 640. In addition, only the part corresponding to the second partition 604 of the second prediction block 634 may be used to generate the final prediction block 640. Therefore, the final prediction block 640 may be determined based on the part corresponding to the first partition 602 of the first prediction block 632 and the part corresponding to the second partition 604 of the second prediction block 634.

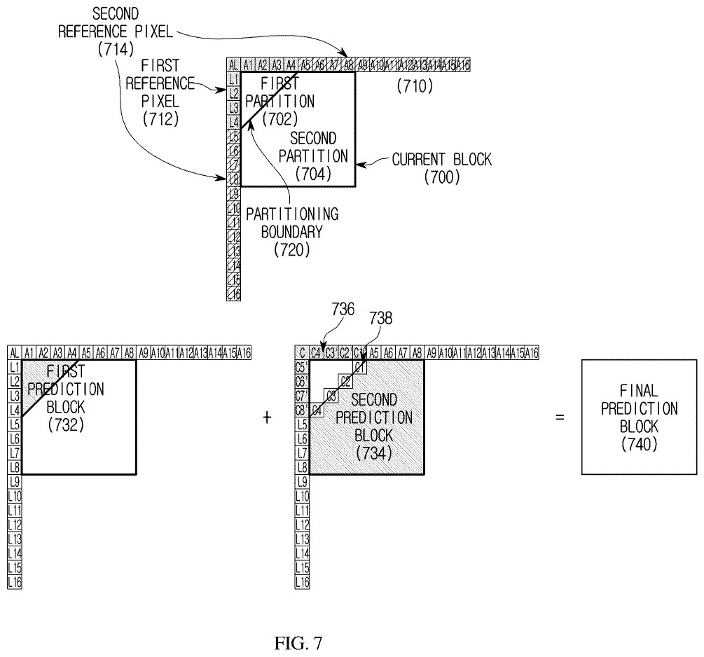

FIG. 7 illustrates another embodiment of a method of determining a prediction block 740 of a current block 700 to which a spatial geometric partitioning mode is applied.

Similar to FIG. 6, in FIG. 7, the current block 700 is partitioned into a first partition 702 and a second partition 704 by a partitioning boundary 720. Then, the intra prediction mode for the partitions 702 and 704 may be determined according to any method of Table 1.

Unlike FIG. 6, in FIG. 7, first, a first prediction block 732 of the first partition 702 may be generated according to the intra prediction mode of the first partition 702. At this time, the first prediction block 732 for the first partition 702 may be generated using the reference pixels A1 to A16, L1 to L16 and AL 710 of the current block 700. In addition, the second prediction block 734 of the second partition 704 may be generated by referring to the second reference pixels A5 to A16 and L5 to L16 714 of the second partition 704 of the current block 700 and the third reference pixels C, C1′, C2′, C3′, C4′, C5′, C6′, C7′ and C8′ 736 derived from the reconstructed first partition 702. Here, the third reference pixels 736 may be used instead of the first reference pixel 712 to generate the second prediction block 734.

Here, the third reference pixels 736 is a reference line pixel generated from the reconstructed pixels C1, C2, C3 and C4 738 of the reconstructed first partition 702. The reconstructed pixels 738 may be located at or around the boundary between the first partition 702 and the second partition 704.

The generated third reference pixels 736 may be a simple copy of the value of the reconstructed pixels 738. Alternatively, the generated third reference pixels 736 may be a value generated from the reconstructed pixels 738 based on a distance between the third reference pixels 736 and the reconstructed pixels 738.

According to one embodiment, one of the third reference pixels C, C1′, C2′, C3′, C4′, C5′, C6′, C7′ and C8′ 736 may be determined to be a value of one of the reconstructed pixels C1, C2, C3 and C4 738. For example, the reconstructed pixel corresponding to the third reference pixel C1′ may be determined based on a distance between the third reference pixel C1′ and each of the reconstructed pixels C1, C2, C3, and C4. Specifically, the third reference pixel C1′ may be determined based on C1, which is the closest reconstructed pixel among C1, C2, C3, and C4. Similarly, other third reference pixels C2′, C3′, C4′, C5′, C6′, C7′, and C8′ may also be determined based on the most appropriate reconstructed pixel selected by considering the distance from each reconstructed pixel.

Alternatively, considering the prediction direction of the intra prediction mode of the second partition 734, the reconstructed pixels 738 referred to in the generation of the third reference pixels 736 may be determined. For example, in the case of a vertical mode, the reconstructed pixels 738 located in the lower direction of the third reference pixels 736 may be referred to in the determination of the third reference pixels 736. In addition, in the case of a horizontal mode, the reconstructed pixels 738 located in the right direction of the third reference pixels 736 may be referred to in the determination of the third reference pixels 736. In addition, in the case of a prediction mode in which the prediction direction is a above left diagonal direction, the reconstructed pixels 738 located in the above left direction of the third reference pixels 736 may be referred to in the determination of the third reference pixels 736. For example, in the third reference pixel C4′, C4 may be referred to in the vertical mode, and C2 may be referred to in the prediction mode in which the prediction direction is the above left diagonal direction. In addition, in the horizontal mode, C4′ may not be generated because it is unnecessary for intra prediction of the second partition. If the reference position of the third reference pixel according to the prediction direction is located in the middle of two reconstructed pixels, the third reference pixel may be determined by referring to a plurality of reconstructed pixels including the two reconstructed pixels.

According to one embodiment, the value of the third reference pixels 736 may be determined based on a weighted sum of the values of two or more reconstructed pixels among the reconstructed pixels 738. At this time, the two or more reconstructed pixels 738 may be determined based on a distance from the third reference pixels 736. In addition, the weight may be determined based on a distance between pixels of the third reference pixels 736 and the reconstructed pixels 738. For example, the third reference pixel C2′ may further refer to the second-closest C2 in addition to the closest C1. In addition, the third reference pixel C2′ may be determined to be a weighted sum of C1 and C2. At this time, the weight required for determining the weighted sum may be derived based on a distance between C2′ and C1 and a distance between C2′ and C2.

According to an embodiment, some of the third reference pixels 736 may be determined from the reconstructed pixels 738. For example, the reference pixels C1′, C2′, C3′, C4′, C5′, C6′, C7′, and C8′ may be determined from the reconstructed pixels 738, and the reference pixel C may be determined from the reconstructed pixels C1, C2, C3, and C4 738. At this time, the reference pixel C may be determined to be an average value of C1 and C4 or an average value of C2 and C3.

Alternatively, according to an embodiment, the second partition 734 may be predicted by directly referring to the reconstructed pixels 738 of the first partition 732 without generating the third reference pixels 736. Accordingly, the second partition 734 may be predicted based on the second reference sample 714 and the reconstructed pixels 738.

The pixel values within the reference line for prediction of the second partition 734 may be derived from the pixels of the first partition 732 reconstructed by various methods. The final prediction block according to the spatial geometric partitioning mode may be generated by combining the two generated prediction blocks 732 and 734.

Both FIGS. 6 and 7 illustrate embodiments of a method of generating a prediction block according to a spatial geometric partitioning mode. A difference between the two embodiments is that in FIG. 6, a prediction block for a first partition and a prediction block for a second partition are independently generated. On the other hand, in FIG. 7, a prediction block for a second partition is generated based on a first partition that has been reconstructed first.

In FIGS. 6 and 7, the reference pixel line adjacent to the current block is used to generate a prediction block of each partitioned partition. However, according to an embodiment, a reference pixel line located N pixels away from the current block may be used to generate a prediction block, where N is a positive integer.

Hereinafter, a method of variably adjusting the width and weights of a blending area when generating a final prediction block for a spatial geometric partitioning mode will be described.

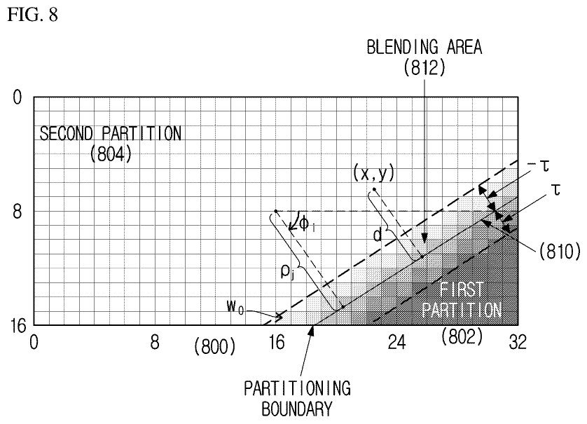

FIG. 8 shows a method of combining two prediction blocks that are partitioned using a partitioning boundary to generate a final prediction block.

In FIG. 8, a coding unit block 800 with a size of 32×16 is partitioned into two partitions 802 and 804 by a partitioning boundary. The area indicated by a dotted line in FIG. 8 represents a blending area 810. The blending area 810 may be defined as an area that includes pixels that are spaced apart by a distance of −τ to τ from the partitioning boundary.

In order to obtain the final prediction block of the coding unit block 800, a prediction signal P₀ for the first partition 802 and a prediction signal P₁ for the second partition 804 may be generated. Then, a prediction signal P_{SGPM} of the final prediction block may be generated by blending the two prediction signals P₀ and P₁ according to Equation 1.

P_{SGPM}=(W₀×P₀+(W−W₀)×P₁+M)>>N [Equation 1]

In Equation 1, P₀ represents a prediction signal of the first partition 802, and P₁ represents a prediction signal of the second partition 804. In addition, in Equation 1, W₀ represents a weight applied to the prediction signal P₀ of the first partition 802. The weights applied to P₀ and P₁ may be set to have all integers greater than 0. Therefore, W₀ may be determined in the range of 0 to W. Here, W may be determined to be a value of an exponent of 2, such as 2, 4, 8, 16, or 32. In addition, the shift operation may be applied to the weighted sum of P₀ and P₁ according to the value of N. Here, N may be a logarithmic value of W with a base of 2. In addition, M is determined to be half of the value of W. Therefore, if W is 8, N is determined to be 3, and M is determined to be 4.

According to one embodiment, if the position of the prediction pixel belongs to the blending area (−τ to τ), a value in the range of 0 to W is used. If the position of the prediction pixel does not belong to the blending area, a value of 0 or W is used. Equation 2 shows a method of determining a weight W₀ according to the position of the prediction pixel.

$${W}_{0} = \{ \begin{matrix}0 , & d ( x , y ) \leq - τ \\ \frac{W}{2 τ} ( d ( x , y ) + τ ) , & - τ < d ( x , y ) \leq τ \\ W , & d ( x , y ) > τ\end{matrix} \qquad [ Equation 2 ]$$

In Equation 2, d(x,y) represents the displacement from the partitioning boundary to the pixel at position (x,y) as shown in FIG. 8. In addition, the threshold τ represents the distance from the partitioning boundary to the end of the blending area. In Equation 2, the weight W₀ may be defined by a ramp function having a displacement and two thresholds −τ and τ.

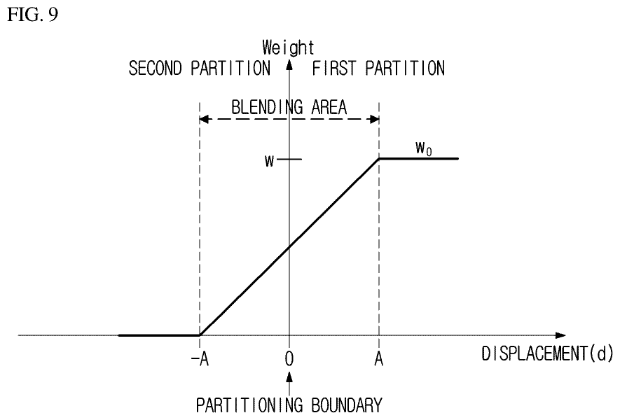

FIG. 9 shows a graph of weights of a prediction signal of each partition 802 according to Equation 2.

The threshold τ represents a distance from the partitioning boundary to the end of the blending area. Therefore, the width of the blending area is determined according to the threshold t. In the present disclosure, the width of the blending area is substantially determined according to the threshold τ and thus the threshold τ may be interpreted as the width of the blending area, or vice versa.

In FIG. 9, the value of τ is fixed to a predetermined value A. For example, the predetermined value may be determined to be 1, 2, 3, 4, etc. In addition, according to an embodiment, the width of the blending area is not fixed, but is adaptively determined according to a predetermined condition, so that the video encoding efficiency can be improved. For example, a wide blending area is suitable for encoding a video image having a large movement of an object in the image or a focus blur. On the other hand, a narrow blending area is suitable for a video image without focus blur or a screen content image. Therefore, a method of variably determining the width of the blending area is discussed below.

Hereinafter, a method of variably determining the width of a blending area based on the size of a current coding unit (CU) block will be described. At this time, the size of the coding unit block may be defined as the width, height, aspect ratio (width/height or height/width), min(width, height), or max(width, height) of the coding unit block. Here, min(width, height) and max(width, height) represent the smaller and larger values among the width and height, respectively.

Equation 3 shows an embodiment of variably determining the width of a blending area based on size information of a coding unit block.

$$τ ( threshold ) = \{ \begin{matrix}0 ( non - blending ) , & size \leq {S}_{1} \\ A , & {S}_{1} < size \leq {S}_{2} \\ 4 A , & size > {S}_{2}\end{matrix} \qquad [ Equation 3 ]$$

In Equation 3, S₁ and S₂ represent different arbitrary positive integers (S₁<S₂). In Equation 3, S₂ may be set to be smaller than the maximum width of the coding unit block or the maximum height of the coding unit block.

In Equation 3, the value of τ representing the width of the blending area is determined according to three size intervals distinguished by S₁ and S₂. Unlike Equation 3, two size intervals may be set, or four or more size intervals may be set.

In FIG. 9, the value of τ is fixed to one, but according to Equation 3, the value of τ may be determined differently depending on the size of the block. Specifically, the value of A in Equation 3 is an arbitrary positive integer. The value of τ may be determined to be a multiple of A for each size interval. For example, the value of τ corresponding to a specific size interval may be determined to be 0, A/4, A/2, A, 2A, 4A, 8A, etc. In addition, according to an embodiment, an arbitrary width value such as 3A or 5A may be used as a width candidate of the blending area. Here, non-blending (τ=0) means generating the final prediction block for the spatial geometric partitioning mode by independent combination without blended prediction generation using a weight based on the partitioning boundary.

In one embodiment, when the min(width, height) of the block is 4, the value of τ may be selected as A/2. In addition, when the min(width, height) of the block is 8, the value of τ may be selected as A. In addition, when the min(width, height) of the block is 16, the value of τ may be selected as 2A. And when the min(width, height) of the block is 32, the value of τ may be selected as 4A. That is, the value of τ may increase in proportion to the size of min(width, height). Here, A is an arbitrary positive integer corresponding to an exponent of 2.

According to one embodiment, the width of the blending area for the current coding unit block may be selected from among N width candidates, where N is an integer greater than or equal to 2. If two width candidates are used in determining the width of the blending area, two width candidates may be selected from various width candidates such as 0, A/4, A/2, A, 2A, 4A, and 8A according to the size of the current coding unit block. In addition, one of the two selected width candidates may be selected for prediction of the current coding unit block. The width candidates may include an arbitrary width such as 3A, 5A, and so on.

For example, when 0 and A are used as width candidates of a blending area, the width of a blending area of a current coding unit block may be determined based on blending area width information indicating one of the two width candidates. The blending area width information may be parsed from a bitstream. Alternatively, the blending area width information may be determined from a current coding unit block or a current picture to which the current coding unit block belongs. For example, whether a reference picture referred to by each partition of the current coding unit block is the same, a slice type of the current picture, whether an image of the current picture is a screen content, a quantization parameter of the current coding unit block, and the like may be considered in determining the blending area width information.

According to one embodiment, the width of the blending area for the current coding unit block may be selected from among M width candidates determined with respect to the size of the current coding unit block. Here, M is an integer greater than or equal to 2. If two width candidates are used in determining the width of the blending area, two width candidates may be selected from among various width candidates such as 0, A/4, A/2, A, 2A, 4A, and 8A according to the size of the current coding unit block. In addition, one of the two selected width candidates may be selected for prediction of the current coding unit block.

At this time, the size of the coding unit block may be defined as the width, height, aspect ratio (width/height or height/width), min(width, height), or max(width, height) of the coding unit block. Here, min(width, height) and max(width, height) represent the smaller and larger values among the width and height, respectively.

For example, if 0 and A are selected as width candidates of the blending area according to the size of the current coding unit block, the width of the blending area of the current coding unit block maybe determined based on blending area width information indicating one of the two selected width candidates. The blending area width information may be determined from the current coding unit block or the picture to which the current coding unit block belongs. Alternatively, the blending area width information may be parsed from a bitstream.

Equation 4 shows a method of selecting two width candidates according to the size of a coding unit block. In the present disclosure, the width candidate substantially represents a candidate of a value of τ.

$$τ ( threshold ) = \{ \begin{matrix}( 0 , A ) , & size \leq {S}_{1} \\ ( A , 4 A ) , & {S}_{1} < size \leq {S}_{2} \\ ( 4 A , 8 A ) , & size > {S}_{2}\end{matrix} \qquad [ Equation 4 ]$$

In Equation 4, S₁ and S₂ represent different arbitrary positive integers (S₁<S₂). In Equation 4, S₂ is set to be smaller than the maximum width of the coding unit block or the maximum height of the coding unit block. According to Equation 4, two width candidates of the blending area are determined based on two variables S₁ and S₂ and the value of size determined by the width and height of the coding unit block. In addition, based on the blending area width information, the width of the blending area of the current coding unit block among the two width candidates may be determined.

For example, if the value of the derived size is greater than S₁ and less than S₂, A and 4A are selected as two width candidates. Then, the optimal blending area is determined among A and 4A. In Equation 4, (0, A), (A, 4A), and (4A, 8A) are used as width candidate pairs for each size condition. However, depending on the embodiment, a different width candidate pair may be applied to each size condition.

Although only two width candidates are defined for each size condition in Equation 4, three or more width candidates may be defined for each size condition depending on the embodiment.

The final prediction signal for the spatial geometric partitioning mode is generated by a weighted sum of two independently predicted prediction signals. At this time, the weighted sum may be calculated based on a ramp function defined by the width −τ and τ of the blending area and the maximum value W of the weight, as shown in FIG. 9. τ may be one of 0, A/4, A/2, A, 2A, 4A, 8A, etc.

According to one embodiment, the maximum value W of the weight may be fixed to 8. According to Equation 1, as the maximum value W of the weight increases, the precision of the weight applied to the weighted sum operation improves. Therefore, when the width of the blending area increases and the precision of the weight needs to increase, the prediction accuracy may be improved by increasing the maximum value W of the weight.

Therefore, the maximum value W of the fixed weight may not always be optimal in an embodiment in which the width of the blending area is variably adjusted. Therefore, when the width of the blending area is variably determined, it may be efficient to also variably determine the maximum value W of the weight. Therefore, hereinafter, an embodiment in which the maximum value of the weight is variably determined by considering the width of the blending area will be described. If the maximum value W of the weight increases, the precision of the weight for the blending area increases, thereby improving the prediction accuracy.

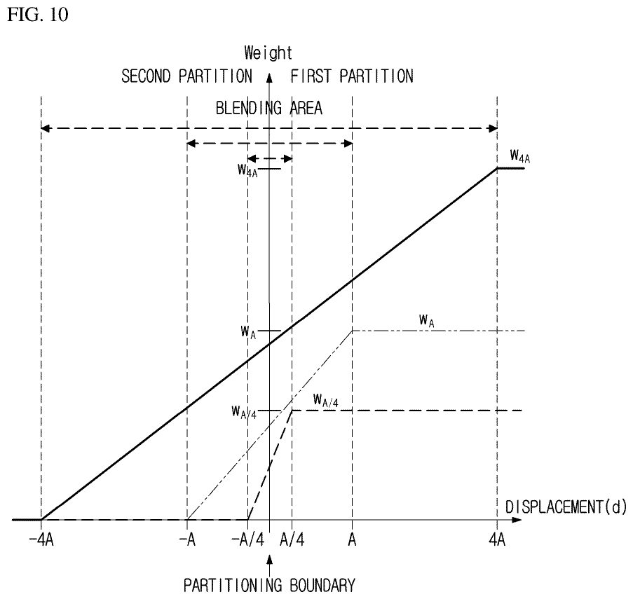

FIG. 10 shows a weight for widths of various blending areas.

According to FIG. 10, regardless of the width 0, A/4, A, 4A of the blending area, the maximum value of the weight W₀ of P₀ is determined to be W. At this time, the maximum value W of the weight W₀ may be determined to be any positive integer. For example, the maximum value W of the weight W₀ may be determined to be 2, 4, 8, 16, 32, or 64. At this time, when W increases, the precision of the weight increases, so that the prediction accuracy in the blending area can be improved. In FIG. 10, 0, A/4, A, 4A are presented as the width of the blending area, but the width of the blending area may be determined to be another value.

When a fixed width of a blending area is applied, a method of variably adjusting the precision of a weight does not have much meaning. However, when the width of the blending area is adaptively determined based on the size of a coding unit block, the prediction accuracy of the final prediction block can be improved by adjusting the precision of the weight according to the maximum value W of the weight W₀.

In the embodiment of FIG. 10, the maximum value W of the weight for the width of various blending areas may be variably determined. However, the maximum value W of the weight is not determined by considering the width of each blending area. That is, since the maximum value W of the weight is fixed regardless of the width of the blending area, there may be a limitation in determining the optimal weight for the width of each different blending area.

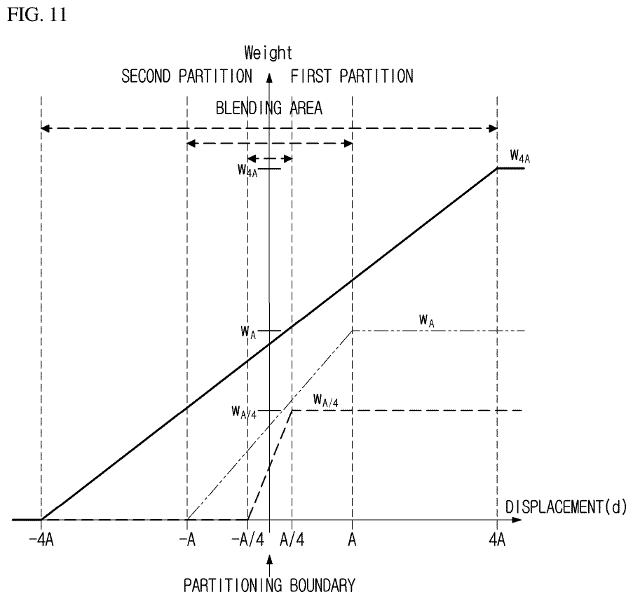

FIG. 11 shows a maximum value of a weight that is variably determined according to a width of a blending area.

According to FIG. 11, if the t value of the blending area is A/4, the maximum value of the weight may be determined to be W_{A/4}. Then, if the τ value of the blending area is A, the maximum value of the weight may be determined to be WA. In addition, if the τ value of the blending area is 4A, the maximum value of the weight may be determined to be W_{4A}. W_{A/4}, W_{A}, and W_{4A}, which are used as the maximum values of the weights in this embodiment, are all arbitrary positive integer values.

Also, although in FIGS. 11, A/4, A, and 4A are used as examples of the τ value of the blending area, but the τ value may be arbitrarily determined. In addition, in FIG. 11, the order of sizes is determined to be W_{A/4}≤W_{A}≤W_{4A} according to the width of the blending area. However, depending on the embodiment, the order of sizes of W_{A/4}, W_{A}, and W_{4A} may be set differently from FIG. 11.

The embodiment of FIG. 11 may also be applied when, instead of one fixed width of the blending area, one of N different width candidates is used for the size of the coding unit block, where N is an integer N≥2.

According to one embodiment, the maximum value of the weight may be determined based on the largest width candidate among the N width candidates of the blending area. For example, if A and 4A are used as the width candidates of the blending area, the maximum value of the weight may be the weight W_{4A} corresponding to 4A, which is the largest width candidate among the width candidates of the blending area.

Conversely, the maximum value of the weight may be determined based on the smallest width candidate among the N width candidates of the blending area. For example, if A and 4A are used as the width candidates of the blending area, the maximum value of the weight may be the weight W_{A} corresponding to A, which is the smallest width candidate among the width candidates of the blending area.

Alternatively, the maximum value of the weight may be determined based on the width candidate selected from among the N width candidates of the blending area. For example, if A is selected from among A and 4A, which are width candidates of the blending area, the maximum value of the weight may be the weight W_{A} corresponding to A, which is the selected width candidate.

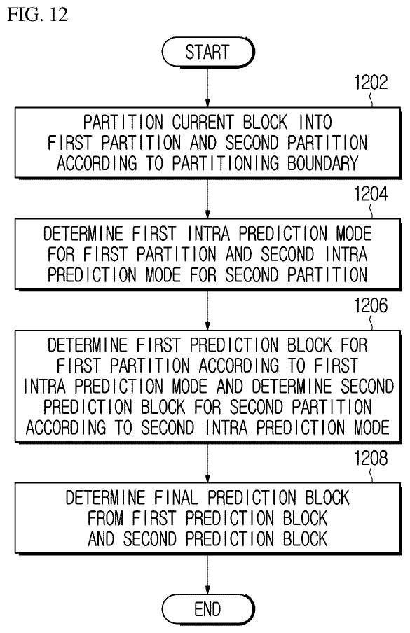

FIG. 12 shows an embodiment of a prediction method according to a spatial geometric division mode according to the present invention.

In step 1202, a current block is partitioned into a first partition and a second partition according to a partitioning boundary. The partitioning boundary may be defined by a partitioning direction and a partitioning position. In addition, the partitioning position may be defined by a distance from a center point of a block or a starting point of the partitioning boundary on the edge of the block.

In step 1204, a first intra prediction mode for the first partition and a second intra prediction mode for the second partition are determined.

According to one embodiment, the first intra prediction mode may be determined from a first reference pixel adjacent to the first partition according to a decoder-side intra prediction mode derivation method. In addition, a second intra prediction mode may be determined from a second reference pixel adjacent to the second partition according to a decoder-side intra prediction mode derivation method.

According to one embodiment, for decoder-side intra prediction mode derivation, a first histogram of gradients representing a gradient distribution of a reference pixel may be generated from the first reference pixel. Then, an intra prediction mode corresponding to a gradient with the highest frequency in the first histogram of gradients may be determined to be the first intra prediction mode.

In addition, for decoder-side intra prediction mode derivation, a second histogram of gradients representing the gradient distribution of the reference pixel may be generated from the second reference pixel. The intra prediction mode corresponding to the gradient with the highest frequency in the second histogram of gradients may be determined to be the second intra prediction mode.

According to one embodiment, intra prediction mode determination method information indicating a method of deriving a first intra prediction mode and a method of deriving a second intra prediction mode may be obtained. In addition, the first intra prediction mode and the second intra prediction mode may be determined according to the intra prediction mode determination method information.

According to one embodiment, the intra prediction mode determination method information may indicate a first determination method for deriving an intra prediction mode from adjacent reference pixels or a second determination method for deriving an intra prediction mode from intra prediction mode information obtained from a bitstream.

According to one embodiment, the intra prediction mode determination method information may independently indicate the determination method of the first intra prediction mode and the determination method of the second intra prediction mode. In addition, the intra prediction mode determination method information may be implemented according to various embodiments for the index described in Table 1.

In step 1206, according to the first intra prediction mode, a first prediction block for the first partition is determined. In addition, according to the second intra prediction mode, a second prediction block for the second partition is determined. The first prediction block and the second prediction block have the same size as the current block. However, when the first prediction block and the second prediction block are combined to determine the final prediction block, the samples of the first partition are determined by the samples of the first prediction block, and the samples of the second partition are determined by the samples of the second prediction block. However, the samples of the blending area around the partitioning boundary of the first partition and the second partition may be determined by the weighted sum of the samples of the first prediction block and the samples of the second prediction block.

According to one embodiment, the first prediction block may be determined with reference to the reference pixels of the current block according to the first intra prediction mode, and the second prediction block may be determined with reference to the reference pixels of the current block according to the second intra prediction mode. In this case, the first prediction block and the second prediction block may be determined independently without reference to each other.

According to one embodiment, the first prediction block may be determined according to the reference pixels of the current block according to the first intra prediction mode. In addition, after the reconstruction of the first prediction block, the second prediction block may be determined according to the second intra prediction mode by referring to the second reference pixel adjacent to the second partition and the reconstructed pixel of the first prediction block.

According to one embodiment, when the second prediction block is predicted by referring to the reconstructed first prediction block, the second prediction block may be determined from a third reference pixel derived from the reconstructed pixel of the first prediction block and the second reference pixel adjacent to the second partition. The third reference pixel may replace the first reference pixel adjacent to the first partition and may be generated by copying the value of the reconstructed pixel of the first prediction block. The third reference pixel may be determined from the reconstructed pixel of the first prediction block at a position corresponding to the third reference pixel. The position corresponding to the third reference pixel may be determined based on a distance between the reconstructed pixel of the first prediction block and the third reference pixel or a prediction direction of an intra prediction mode of the second partition. Alternatively, it is characterized in that the third reference pixel may be determined by combining two or more reconstructed pixels of the first prediction block based on the distance between the reconstructed pixel of the first prediction block and the third reference pixel. The reconstructed pixel of the first prediction block, which is referred to in the generation of the third reference pixel, may be located at or around the boundary between the first partition and the second partition. Alternatively, according to an embodiment, the second partition may be predicted by directly referring to the reconstructed pixel of the first prediction block without generating the third reference pixel.

In step 1208, a final prediction block is determined from the first prediction block and the second prediction block.

According to one embodiment, step 1208 may further include determining a width of a blending area around a partitioning boundary, and determining a first weight and a second weight for determining a final prediction sample of the blending area based on the width of the blending area. In addition, the final prediction block may be determined from the first prediction block and the second prediction block based on the first weight and the second weight.

According to one embodiment, the width of the blending area may be determined based on the size value of the current block.

According to one embodiment, the width of the blending area may be determined according to a size interval that includes the size value of the current block.

According to one embodiment, the width of the blending area may be selected from among a plurality of width candidates corresponding to a size interval including the size value of the current block. At this time, the width of the blending area may be selected from among the plurality of width candidates based on blending area width information indicating the width of the blending area parsed from a bitstream.

Alternatively, the width of the blending area may be determined based on blending area width information indicating the width candidate of the blending area among a plurality of width candidates determined regardless of the size of the current block.

According to one embodiment, the size value of the current block may be determined by at least one of the width of the current block, the height of the current block, a larger value among the width and height of the current block, a smaller value among the width and height of the current block, or a ratio of the width and height of the current block.

According to one embodiment, the width of the blending area may be determined depending on whether a current picture or a current slice including the current block is a screen content image. If the current picture or the current slice is a screen content image, the width of the blending area may be determined to be 0 regardless of the size of the current block. Alternatively, under the above condition, the width of the blending area may be determined to be A/4 regardless of the size of the current block.

According to one embodiment, the method may include determining a maximum value of the first weight and the second weight based on the width of the blending area and determining the first weight and the second weight based on the maximum value. In addition, the maximum value of the first weight and the second weight may be set to be larger as the width of the blending area increases. The maximum value of the first weight and the second weight may be determined to be one of 2, 4, 8, 16, 32, 64, and 128 according to the width of the blending area.

According to one embodiment, the method may include determining a maximum value of the first weight and the second weight based on width candidates of the blending area applied to the current block and determining the first weight and the second weight based on the maximum value. The maximum value of the first weight and the second weight may be determined based on a largest width candidate or a smallest width candidate among the width candidates of the blending area. The maximum value of the first weight and the second weight may be determined to be one based on at least one of a plurality of width candidates of the blending area among 2, 4, 8, 16, 32, 64, and 128.

According to one embodiment, regardless of the width of the blending area, the maximum values of the first weight and the second weight may be fixed. For example, the maximum value of the first weight and the second weight may be fixed to one of 2, 4, 8, 16, 32, 64, and 128.

According to one embodiment, the first weight and the second weight may be determined based on a distance between a position of a sample of the blending area and the partitioning boundary.

According to one embodiment, the first weight and the second weight may be determined based on a nonlinear function that receives the position of the sample of the blending area and the distance of the partitioning boundary. The nonlinear function may be composed of at least one of a higher-order function than a quadratic function, an exponential function, or a logarithmic function.

The final predicted block of the current block determined in steps 1202 to 1208 may be used to encode and decode the current block.

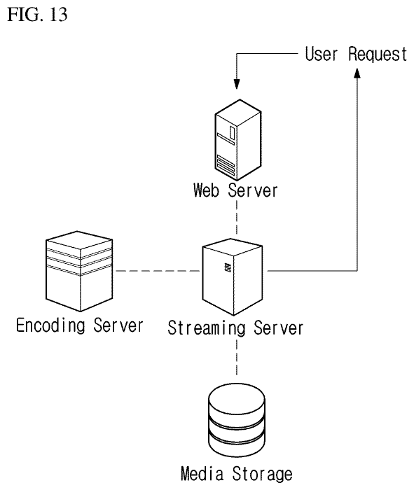

FIG. 13 exemplary illustrates a content streaming system to which an embodiment according to the present invention is applicable.

As illustrated in FIG. 13, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from a media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

The present invention may be used in an apparatus for encoding/decoding an image and a recording medium for storing a bitstream.

1. An image decoding method comprising:
partitioning a current block into a first partition and a second partition according to a partitioning boundary;
determining a first intra prediction mode for the first partition and a second intra prediction mode for the second partition;
determining a first prediction block for the first partition according to the first intra prediction mode and a second prediction block for the second partition according to the second intra prediction mode; and
determining a final prediction block from the first prediction block and the second prediction block.

2. The image decoding method of claim 1, wherein the first intra prediction mode is determined from a first reference pixel adjacent to the first partition and the second intra prediction mode is determined from a second reference pixel adjacent to the second partition.

3. The image decoding method of claim 2,
wherein a first histogram of gradients representing a gradient distribution of a reference pixel is generated from the first reference pixel and an intra prediction mode corresponding to a gradient with a highest frequency in the first histogram of gradients is determined to the first intra prediction mode, and
wherein a second histogram of gradients representing a gradient distribution of a reference pixel is generated from the second reference pixel and an intra prediction mode corresponding to a highest frequency in the second histogram of gradients is determined to be the second intra prediction mode.

4. The image decoding method of claim 1, further comprising obtaining intra prediction mode determination method information indicating a method of deriving a method of deriving the first intra prediction mode and a method of deriving the second intra prediction mode,
wherein the first intra prediction mode and the second intra prediction mode are determined according to the intra prediction mode determination method information.

5. The image decoding method of claim 4, wherein the intra prediction mode determination method information indicates a first determination method for deriving an intra prediction mode from adjacent reference pixels or a second determination method for deriving an intra prediction mode from intra prediction mode information obtained from a bitstream.

6. The image decoding method of claim 4, wherein the intra prediction mode determination method information independently indicates a determination method of the first intra prediction mode and a determination method of the second intra prediction mode.

7. The image decoding method of claim 1,
wherein the first prediction block is determined by referring to a reference pixel of the current block according to the first intra prediction mode,
wherein the second prediction block is determined by referring to the reference pixel of the current block according to the second intra prediction mode, and
wherein the first prediction block and the second prediction block are independently determined.

8. The image decoding method of claim 1,
wherein the first prediction block is determined by referring to a reference pixel of the current block according to the first intra prediction mode,
wherein the second prediction block is determined by referring to a second reference pixel adjacent to the second partition and a reconstructed pixel of the first prediction block according to the second intra prediction mode, and
wherein the first prediction block is determined and then the second prediction block is determined.

9. The image decoding method of claim 8,
wherein the second prediction is determined from a third reference pixel derived from the reconstructed pixel of the first prediction block and a second reference pixel adjacent to the second partition, and
wherein the third reference pixel replaces a first reference pixel adjacent to the first partition.

10. The image decoding method of claim 9, wherein a value of the third reference pixel is determined by copying a value of the reconstructed pixel of the first prediction block or by combining two or more reconstructed pixels of the first prediction block based on the reconstructed pixel of the first prediction block and a distance from the third reference pixel.

11. The image decoding method of claim 1, further comprising:
determining a width of a blending area around the partitioning boundary; and
determining a first weight and a second weight for determining a final prediction sample of the blending area based on the width of the blending area,
wherein the final prediction block is determined from the first prediction block and the second prediction block, based on the first weight and the second weight.

12. The image decoding method of claim 11,
wherein in the determining the width of the blending area, the width of the blending area is determined based on a size value of the current block, and
wherein the size value of the current block is determined by at least one of a width of the current block, a height of the current block, a larger value among the width and height of the current block, a smaller value among the width and height of the current block, or a ratio of the width and height of the current block.

13. The image decoding method of claim 11, wherein the width of the blending area is selected from among a plurality of width candidates based on blending area width information indicating the width of the blending area.

14. The image decoding method of claim 11, wherein the width of the blending area is determined to be 0 or ¼ when a current picture or a current slice including the current block is a screen content image.

15. The image decoding method of claim 11, wherein the determining the first weight and the second weight comprises:
determining a maximum value of the first weight and the second weight based on the width of the blending area; and
determining the first weight and the second weight based on the maximum value,
wherein the maximum value of the first weight and the second weight is set to be larger as the width of the blending area increases.

16. The image decoding method of claim 11, wherein the determining the first weight and the second weight comprises:
determining the maximum value of the first weight and the second weight based on width candidates of the blending area applied to the current block; and
determining the first weight and the second weight based on the maximum value.

17. The image decoding method of claim 11, wherein in the determining of the first weight and the second weight, the first weight and the second weight are determined based on a position of a sample of the blending area and a distance from the partitioning boundary.

18. An image encoding method comprising:
partitioning a current block into a first partition and a second partition according to a partitioning boundary;
determining a first intra prediction mode for the first partition and a second intra prediction mode for the second partition;
determining a first prediction block for the first partition according to the first intra prediction mode and a second prediction block for the second partition according to the second intra prediction mode; and
determining a final prediction block from the first prediction block and the second prediction block.

19. (canceled)

20. A bitstream transmission method of transmitting a bitstream generated by an image encoding method, the bitstream transmission method comprising:
encoding an image based on the image encoding method; and
transmitting the bitstream including the encoded image,
wherein the image encoding method comprises:
partitioning a current block into a first partition and a second partition according to a partitioning boundary;
determining a first intra prediction mode for the first partition and a second intra prediction mode for the second partition;
determining a first prediction block for the first partition according to the first intra prediction mode and a second prediction block for the second partition according to the second intra prediction mode; and
determining a final prediction block from the first prediction block and the second prediction block.
